(19) United States
(12) Patent Application Publication
(10) Pub. No.: US 2010/0083235 A1
(43) Pub. Date: Apr. 1, 2010

(54) DEBUG SYSTEM FOR DIAGRAM OF PROGRAMMABLE CONTROLLER, ITS PROGRAMMING DEVICE AND ITS PROGRAM

(75) Inventors: Harumi Hozoji, Fuchu-shi (JP); Masahide Ono, Tokyo (JP); Hajime Taruishi, Sayama-shi (JP); Junichi Kawamoto, Fuchu-shi (JP); Shigeru Kajihara, Kunitachi-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/597,516

(22) PCT Filed: Apr. 25, 2008
(86) PCT No.: PCT/JP08/58065

§ 371 Date: Oct. 26, 2009

(30) Foreign Application Priority Data
Apr. 26, 2007 (JP) 2007-117113
May 14, 2007 (JP) 2007-128320

(51) Int. Cl. G06F 9/44

(52) U.S. Cl. 717/127

(57) ABSTRACT

A debug system is provided with a control program compilation processing unit 11a that generates a control program for producing a first instruction for designating a connecting state on an input side of a connecting point with respect to the connecting point for connecting symbols, its connecting destination, a first internal variable, a second instruction for designating a connecting state on an output side of a connecting point and its connecting destination, and a second internal variable; and a wire force processing unit 11b that commands that the first instruction and the first variable are rewritten to a third instruction and a third variable or that either one of the first instruction and the first variable is rewritten to the third instruction or the third variable and commands that the second instruction and the second variable are rewritten to a fourth instruction and a fourth variable or that either one of the second instruction and the second variable is rewritten to the fourth instruction or the fourth variable by rewriting.

### TECHNICAL FIELD

The present invention relates to a control system for a plant as typified by an iron-and-steel plant, a papermaking plant or a chemical plant. More particularly, the present invention relates to a debug system for diagram of a programmable controller using a ladder diagram (LD) language and a function block diagram (FBD) language, and also relates to a programming device of the debug system and its program.

### BACKGROUND ART

In general, in FA (Factory Automation) field including an assembling work such as iron-and-steel, papermaking plants and automobile industry, PA (Process Automation) field for a chemical plant or the like and in the monitoring/control field for an industrial system as typified by a public system such as water and sewerage system, a programmable controller (referred to as “PLC” hereinafter) using a control program described by a graphical language is used widely.

As the graphical language for the PLC, there are adopted global languages according to International Standard IEC61131-3 by International Electrotechnical Commission.

As a programming tool using such languages, there is a programming software (e.g. ladder editor etc.) in widespread use. Since a personal computer is capable of producing a diagram in the form of containing symbols, a program can be produced and compiled on the basis of the diagram with ease.

For a normal operation according to the original design, generally, the so-produced program may be corrected or modified by a debug operation. In this debug operation, by executing the program in a state where an instrument is connected to the PLC, it is performed to confirm whether the instrument is operating as designed or not.

The ladder editor enabling a diagram to be created on the display screen of the personal computer has a mode of confirming the operation of the diagram by running a simulation of switching on or off (ON/OFF) contact points in the debug operation forcibly.

For instance, if the ladder editor is installed in the form of an application running on a Windows® system on a personal computer, there is displayed a dialog box (not shown) indicating ON/OFF states of contacts on condition of setting a test mode (or debug mode). Then, an operator can set ON/OFF states of the contacts through an operation screen of the computer.

However, it should be noted that the debug operation by such an operator's operation becomes more complex as the number of contacts to be switched ON gets increased, so that the efficiency of the debug operation is reduced remarkably.

In order to solve such a program, there is a method of replacing some contacts with a dummy circuit collectively during the debug operation. Thus, by reducing the contacts to be switched ON to the minimum necessary, the above-mentioned operator's trouble is saved.

In the above method, however, it is necessary to return the dummy circuit to the original circuit after completion of the debug operation. If an operator forgets this returning of the dummy circuit, then the program would operate abnormally.

Therefore, in order to promote the efficiency of the debug operation of the program by simplifying an operator's handling required for the simulation of switching ON the contacts forcibly, there is disclosed a method of carrying out a designation process of designating special contacts to be switched ON/OFF from all contacts on connecting lines between an input-side bus line and an output-side bus line, in a prescribed course from the input-side bus line and an ON/OFF process of switching ON/OFF the so-designated contacts collectively (Patent Document No. 1).

Patent Document No. 1:
Japanese Patent Publication Laid-open No. 2000-276212 (page 1, FIG. 1)

### DISCLOSURE OF THE INVENTION

However, although there is known a method of forcibly setting, with respect to instruction words such as “CONTACT”, their variables during the debug operation of a diagram (the method may be also referred to as “contact force”), it is impossible to establish a variable to a connecting point (incl. a branch point). Thus, the debug operation of the diagram following after the connecting point cannot be accomplished with ease.

In the method of manufacturing a dummy circuit for the debug operation, additionally, a new problem may occur because the method requires an operation of restoring the program and furthermore, there is a possibility that the operation is failed.

Still further, if the control program is in operation, its operation has to be once stopped to change the diagram (circuit diagram) prior to the debug operation, requiring great care.

In consideration of the above-mentioned problems, an object of the present invention is to provide, in a debug system for diagram of a programmable controller, which system produces and displays a diagram made from a ladder diagram language and a function block diagram language on a display screen and produces an object control program based on the diagram, the debug system for diagram of the programmable controller capable of carrying out an easy debugging of the diagram having connecting points containing branch points of the control program in operation. In addition, the present invention is to provide a programming device of the above debug system and a program of the programming device.

In order to attain the above object, according to an aspect of the present invention, there is provided a debug system for diagram, which consists of a programming device for producing a diagram on a display screen by a predetermined diagram language and further producing an object control program based on the diagram and a programmable controller for loading the object control program thereby to execute it, the programming device comprising a control program compilation processing unit for producing the object control program that generates, with respect to a connecting point for connecting symbols displayed on the display screen: a first instruction for designating a connecting state on an input side of the connecting point and a connecting destination thereof; a first internal variable; a second instruction for designating a connecting state on an output side of the connecting point and a connecting destination thereof; and a second internal variable, and a wire force setting processing unit for commanding that the first instruction and the first variable are rewritten to a third instruction and a third variable or that either one of the first instruction and the first variable is rewritten to the third instruction or the third variable and also commanding that the second instruction and the second variable are rewritten to a fourth instruction and a fourth variable or that either one of the second instruction and the second variable is rewritten to the fourth instruction or the fourth variable, wherein when a change order for changing the connecting states and the connection destinations on the input side and the output side of the connecting point is transmitted from the programming device to the programmable controller, the programmable controller carries out debugging of the diagram based on the change order during execution of the object control program.

According to an aspect of the present invention, there is also provided a programming device in a debug system for diagram, which consists of the programming device for producing a diagram on a display screen by a predetermined diagram language and further producing an object control program based on the diagram and a programmable controller for loading the object control program thereby to execute it, the programming device comprising a control program compilation processing unit for producing the object control program that generates, with respect to a connecting point for connecting symbols displayed on the display screen: a first instruction for designating a connecting state on an input side of the connecting point and a connecting destination thereof; a first internal variable; a second instruction for designating a connecting state on an output side of the connecting point and a connecting destination thereof; and a second internal variable, and a wire force setting processing unit for commanding that the first instruction and the first variable are rewritten to a third instruction and a third variable or that either one of the first instruction and the first variable is rewritten to the third instruction or the third variable and also commanding that the second instruction and the second variable are rewritten to a fourth instruction and a fourth variable or that either one of the second instruction and the second variable is rewritten to the fourth instruction or the fourth variable.

According to an aspect of the present invention, there is also provided a program of a debug system for diagram, which consists of a programming device for producing a diagram on a display screen by a predetermined diagram language and further producing an object control program based on the diagram and a programmable controller for loading the object control program thereby to execute it, the program having a control program compilation function of producing the object control program that generates: with respect to a connecting point for connecting symbols displayed on the display screen; a first instruction for designating a connecting state on an input side of the connecting point and a connecting destination thereof; a first internal variable; a second instruction for designating a connecting state on an output side of the connecting point and a connecting destination thereof; and a second internal variable, and a wire force setting processing function of commanding that the first instruction and the first variable are rewritten to a third instruction and a third variable or that either one of the first instruction and the first variable is rewritten to the third instruction or the third variable and also commanding that the second instruction and the second variable are rewritten to a fourth instruction and a fourth variable or that either one of the second instruction and the second variable is rewritten to the fourth instruction or the fourth variable, wherein when a change order for changing the connecting states and the connection destinations on the input side and the output side of the connecting point is transmitted from the programming device to the controller, the programmable controller carries out debugging of the diagram based on the change order during execution of the object control program.

### BRIEF DESCRIPTION OF DRAWINGS

FIG. 1 is a constitutive view of a programming device of the present invention.

FIG. 2 is a view showing an example of a diagram to explain a first embodiment of the present invention.

FIG. 3 is a view showing an example of an object control program to explain the first embodiment.

FIG. 4 is a view showing an example of setting in cutting off a connection between connecting points of the present invention.

FIG. 5 is a view showing an example of setting an internal variable in cutting off the connection between the connecting points of the present invention.

FIG. 6 is a flow chart of an operation of setting the internal variable in cutting off the connection between the connecting points of the present invention.

FIG. 7 is a view showing an example of a dialog box for a wire force setting between the connecting points of the present invention.

FIG. 8 is a view showing an example of a diagram to explain a second embodiment of the present invention.

FIG. 9 is a view showing the example of the diagram to explain the operation of the second embodiment.

FIG. 10 is a view showing an example of an object control program to explain the operation of the second embodiment.

FIG. 11 is a view showing an example of a diagram to explain the operation of a third embodiment of the present invention.

FIG. 12 is a view showing an example of an object control program to explain the operation of the third embodiment.

FIG. 13 is a view showing an example of a diagram to explain the operation of a fourth embodiment of the present invention.

FIG. 14 is a view showing an example of an object control program to explain the operation of the fourth embodiment.

FIG. 15 is a view showing an example of a diagram to explain the operation of a fifth embodiment of the present invention.

FIG. 16 is a view showing an example of an object control program to explain the operation of the fifth embodiment.

### BEST MODE FOR CARRYING OUT THE INVENTION

The present invention will be described below, with reference to drawings.

### 1^{st}. Embodiment

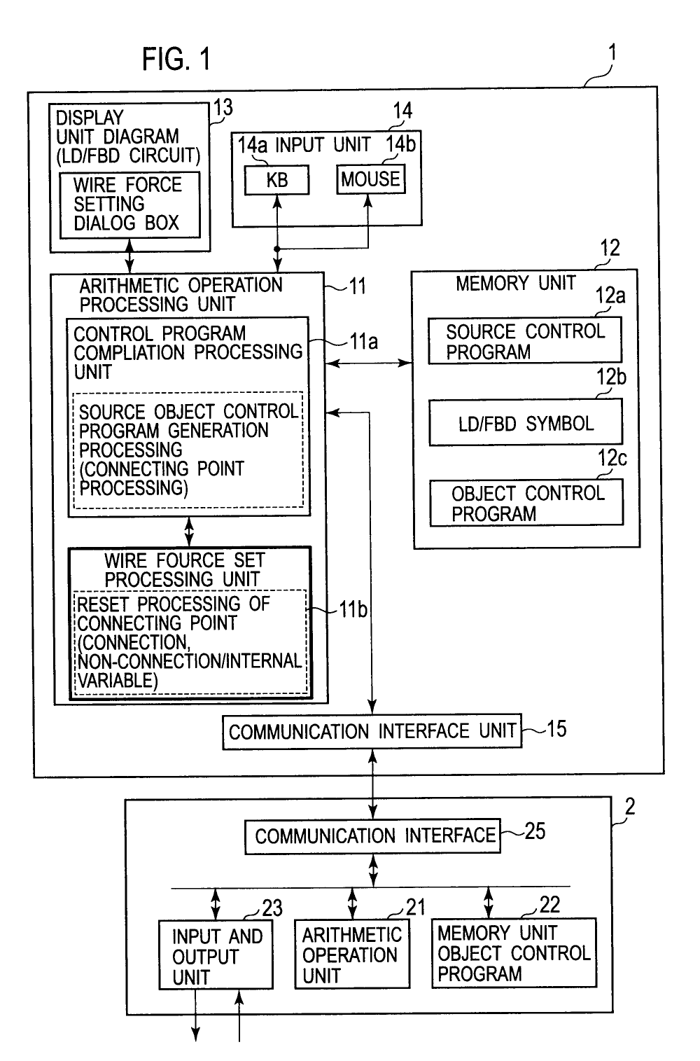

The first embodiment of the present invention will be described with reference to FIGS. 1 to 7. FIG. 1 is a block diagram showing the constitution of a debug system for diagram of PLC.

A programming device 1 creates a diagram and an object control program based on the diagram. Then, this object control program is downloaded to a programmable controller (PLC) 2 controlling an object to be controlled and subsequently used therein.

Here, the terminology “diagram” designates a circuit diagram which is produced with the use of the ladder diagram language and the function diagram language according to International Standard IEC61131-3 by International Electrotechnical Commission.

The programming device 1 comprises an arithmetic operation processing unit 11 that creates a diagram and also produces instructions and internal variables for each designating a connecting state (connecting or non-connecting) on both input and output sides of each connecting point with respect to the connecting points for connecting symbols in the diagram, and a connecting destination of the connecting point thereby to produce an object control program based on the diagram, a memory unit 12 that stores a source control program for producing the diagram, LE/FBD symbols and the object control program for the source control program, a display unit 13 that displays the diagram and an operating screen, such as dialog boxes, an input unit 14 for various input operations for producing the diagram and the object control program and a communication interface unit 15.

The PLC 2 comprises a communication interface 25 receiving the object control program transmitted from the programming device 1, a memory unit 22 storing the received object control program, an arithmetic operation processing unit 21 executing the object control program and an input-and-output unit 23 processing input/output signals to and from an object to be controlled in accordance with an instruction from the arithmetic operation processing unit 21.

Next, the constitution of respective parts of the programming device 1 will be described. The programming device 1 may be constructed by, for example, a personal computer. The arithmetic operation processing unit 11 consists of a CPU unit including a not-shown CPU and a main memory and also comprises a control program compilation processing unit 11a having a program compiler to generate the source control program for creating the diagram and the object control program based on the diagram and a wire force setting processing unit 11b of the present invention.

The memory unit 12 is formed by a hard-disc driver and adapted so as to store symbols 12b for the diagram, the produced source control program 12a and the object control program 12c.

In detail, the control program compilation processing unit 11a produces the diagram and further creates the object control program for generating: a first instruction for designating the connecting state (connecting or non-connecting) on an input side of a connecting point with respect to the connecting point for connecting symbols in the diagram displayed on a display screen and its connecting destination of the connecting point; a first internal variable; a second instruction for designating the connecting state (connecting or non-connecting) on the output side of the connecting point and its connecting destination; and a second internal variable.

Then, the wire force setting processing unit 11b gives an instruction to rewrite the first instruction and the first variable to a third instruction and a third variable respectively or to rewrite either one of the third instruction and the third variable to the third instruction or the third variable and also gives another instruction to rewrite the second instruction and the second variable to a fourth instruction and a fourth variable respectively or to rewrite either one of the second instruction and the second variable to the fourth instruction or the fourth variable.

That is, the arithmetic operation processing unit 11 has the functions of: designating the connecting/non-connecting of the input and output sides of a connecting point (incl. a branch point) in the diagram; setting internal an variable of the connecting point; cutting off a connecting line between optional connecting points; and setting an internal variable about a power flow on the downstream side of the connecting point.

Here, the internal variable designates a variable that is not displayed on the screen of the display unit 13. While, a variable displayed on the screen will be referred to as “variable” simply.

In addition, the wire force setting processing unit 11b rewrites only the third instruction/the third internal variable and the fourth instruction/the fourth internal variable in accordance with a command from the controller 2 in operation, and further commands a debugging of the so-changed diagram to the PLC 2.

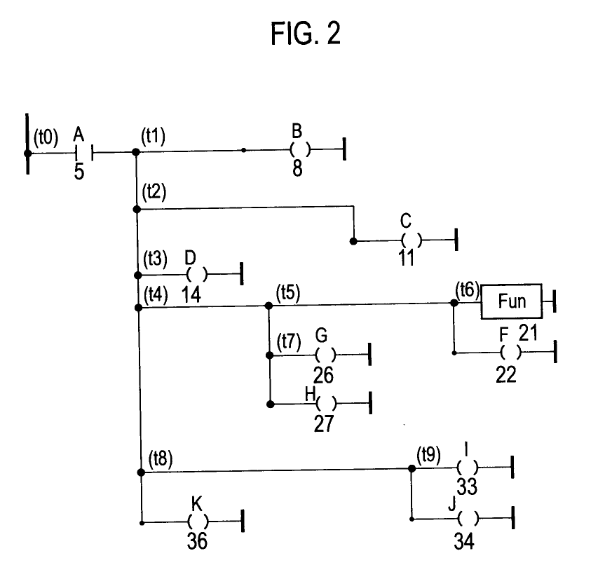

Next, the operation of the so-constructed programming device 1 in processing a connecting point will be described with reference to FIGS. 2 to 7.

FIG. 2 is a view showing one example of the diagram produced by the programming device 1. For instance, “A” designates a variable A of a contact point and its symbol is represented by “∥”. Similarly, a variable B designates a variable of a coil and its symbol is represented by “( )”. Numerals below the respective symbols denote step numbers in the later-mentioned object control program.

As for a connecting point in symbols between the contact point of the variable A and the coil of the variable B, (t1) denotes an internal variable of the connecting point, which is not displayed on the operating screen. The internal variable (t1) of this connecting point forms not only the connecting point between the contact point of the variable A and the coil of the variable B but also a branch point connected to a connecting line between the connecting point and an internal variable (t2) of another connecting point positioned downward of the diagram.

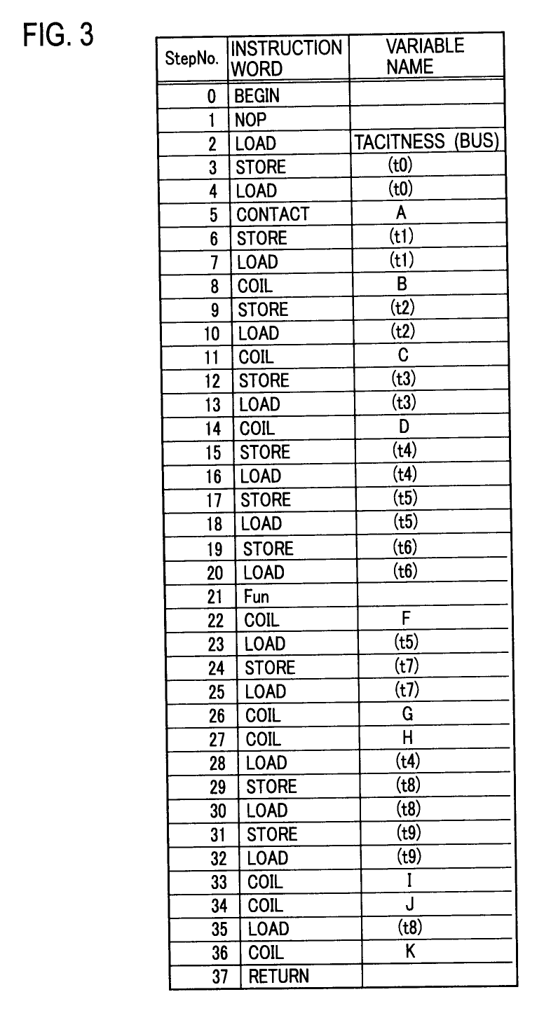

FIG. 3 is a view showing one example of the object control program produced in accordance with the diagram. In the figure, a left column designates step numbers, a middle column instruction words corresponding to the respective steps, and a right column designates variable names of the instruction words. As shown in FIG. 3, all of the internal variables (t0)˜(t9) corresponding to the connecting points in the diagram are defined, in the instruction word, as “LOAD” or “STORE” in assembler language, and each internal variable is supplied after two steps of instructions.

This setting of variables of the connecting points could be accomplished in the process of producing a diagram. Alternatively, after producing the diagram, it may be performed to specify a connecting point by means of a cursor and successively click the cursor's position for setting a variable. After specifying connecting points, alternatively, the instruction word “LOAD” or “STORE” may be defined to the specified connecting points collectively.

In general, points for connecting input-output terminals of symbols are defined as “connecting points”. However, according to the present invention, as typified by the connecting lines between the internal variable (t4) and the internal variable (t5) and between the internal variable (t5) and the internal variable (t6), it is also possible to regard both ends of a connecting line interposing no symbol between the connecting points as “symbols”, establishing the connecting points.

FIG. 3 illustrates a case of setting the interval variables (t0)˜(t9) of these connecting points as connecting points all of which are not displayed in the diagram.

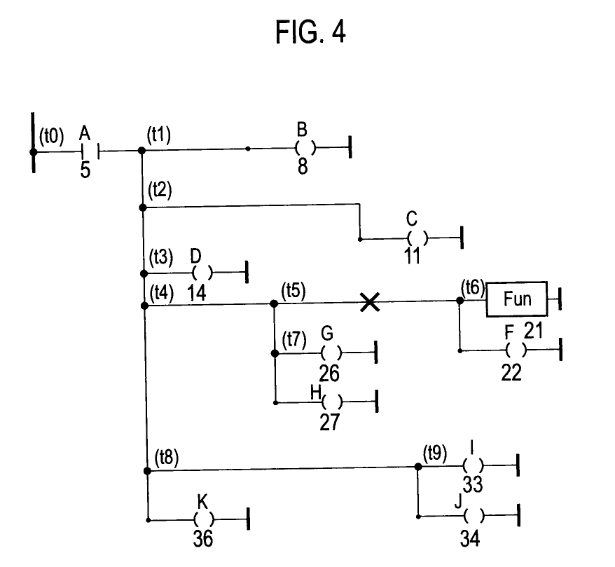

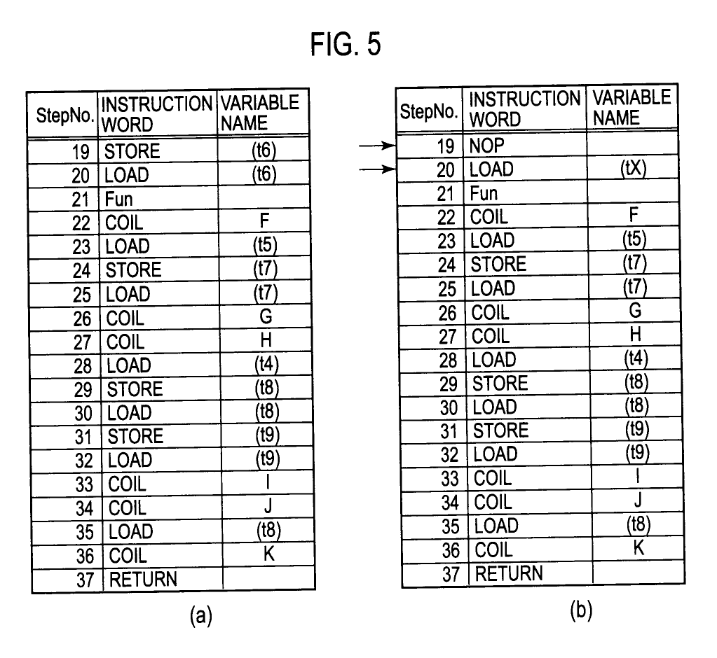

Next, with respect to the diagram where the connecting points are established in the above way, the operation of a wire force setting processing in cutting off a connection between connecting points in the diagram will be described with reference to FIGS. 4 and 5.

We now describe, for instance, the operation of debugging a downstream circuit composed a function block “Fun” and a coil F by cutting off the connecting line between the internal variable (t5) and the internal variable (t6) at a point shown with mark “X”, as shown in FIG. 4.

This cutoff is accomplished by changing an instruction of “STORE” at step 19 [FIG. 5(a)] in the object control program shown in FIG. 3 to an instruction of “NOP”, effecting a delinking of the power flow on the output side.

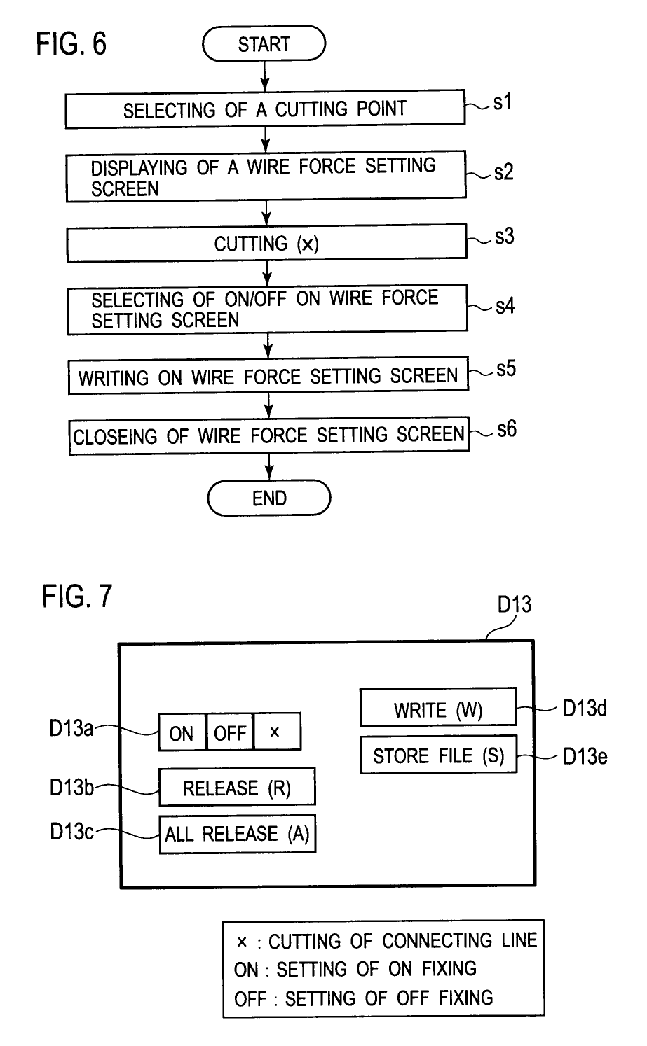

Next, the operation of cutting off a connection between connecting points and subsequently setting an internal variable of the connecting point on the downstream side of the resulting breakpoint will be described with reference to FIGS. 6 and 7. FIG. 6 is a flow chart of the operation, while FIG. 7 is a view showing an example of a dialog box D13 for operating a wire force setting displayed on the display unit 13.

First, a diagram produced in advance is displayed, and in addition, the cursor is moved toward a cutting position of the connecting line, for example, onto the connecting line between the internal variable (t5) and the internal variable (t6) (s1). Then, by clicking the screen at that position, the dialog box D13 is displayed (s2).

Next, an icon “X” in a dialog box D13a is clicked. Consequently, the instruction of “STORE” at step 19 of the source control program on the main memory in the arithmetic operation processing unit 11 is rewritten to the instruction of “NOP”, so that the mark “X” shown in FIG. 4 is displayed on the screen (s3).

Further, an icon “ON” or “OFF” D13a is clicked here. Consequently, at step 20 [(FIG. 5(b)], the internal variable (t6) is rewritten to an internal variable (tX) and successively, the same (tX) is written as the internal variable of the connecting point on the downstream side of the cutting position, into the main memory in the arithmetic operation processing unit 11.

Next, when clicking an icon “WRITE (W)” D13d, it is commanded to rewrite the object control program of the PLC 2 (s5).

Thus, by cutting off the connecting line of the diagram and further setting an internal variable of a connecting point as the origin of a power flow on the downstream side of the breakpoint, it is possible to carry out debugging of a circuit on the downstream side of the diagram with an alteration of the operating object control program.

Then, this alteration may be also cancelled by clicking an icon “RELEASE (R)” D13b to reconfigure the object control program.

In addition, if there are a plurality of changing points in the diagram, the diagram could be restored to the state before debugging by first clicking of an icon “ALL RELEASE (A)” and successively clicking the icon “WRITE (W)” D12d to rewrite the information of only the step of the changed connecting point.

If it is not performed to download an object control program of a change part, it is also possible to write the program into the memory unit 12 by clicking an icon “STORE FILE (s)” D13e.

Thus, according to the present invention, by rewriting, with respect to the object control program of the operating controller, an instruction of connecting or non-connecting a connecting point of the diagram to be changed and its connecting destination (internal variable) in case of connecting the connecting point, it is possible to divorce a circuit for debugging from other circuits in even a diagram including a branch point, accomplishing an easy debugging of the circuit.

In addition, it is also possible to restore the program to its state before changing, in block.

### 2^{nd}. Embodiment

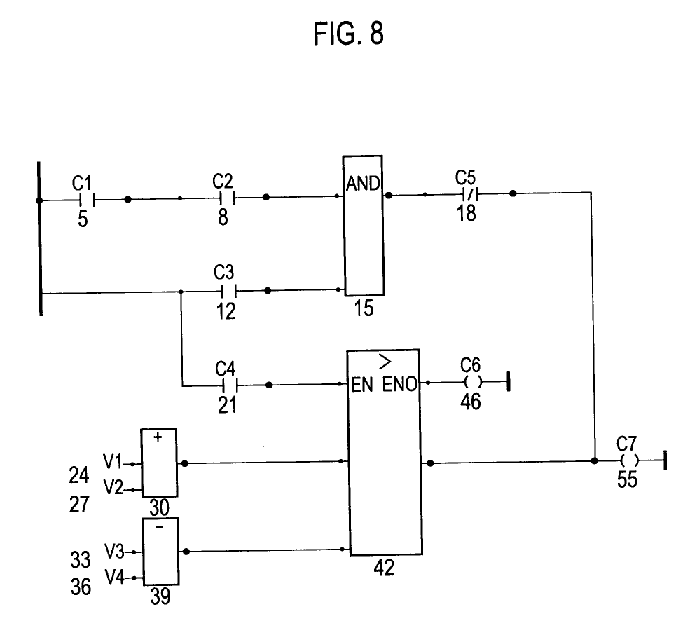

The diagram debug system of the PLC in accordance with the second embodiment of the present invention will be described with reference to FIGS. 8 to 10. In the second embodiment, respective parts identical to those of the debug system of the PLC of the first embodiment are indicated with the same reference numerals respectively, and their descriptions are eliminated.

The second embodiment differs from the first embodiment in that the wire force setting processing unit 11 of the first embodiment has the function of cutting off a connecting line and also setting an internal variable of the connecting point, while the same unit of the second embodiment further has an additional function of forming a bypass circuit for the circuit containing the connecting point.

The operation will be described by a diagram of FIG. 8 as an example, below. FIG. 8 illustrates the diagram comprising respective contact points composed of variables C1˜C5, coils composed of variables C6, C7, a function block diagram (referred to as “FBD” hereinafter), “AND (logical addition)”, FBD “+ (adder)”, FBD “− (subtractor)” and FBD “> (comparator)”.

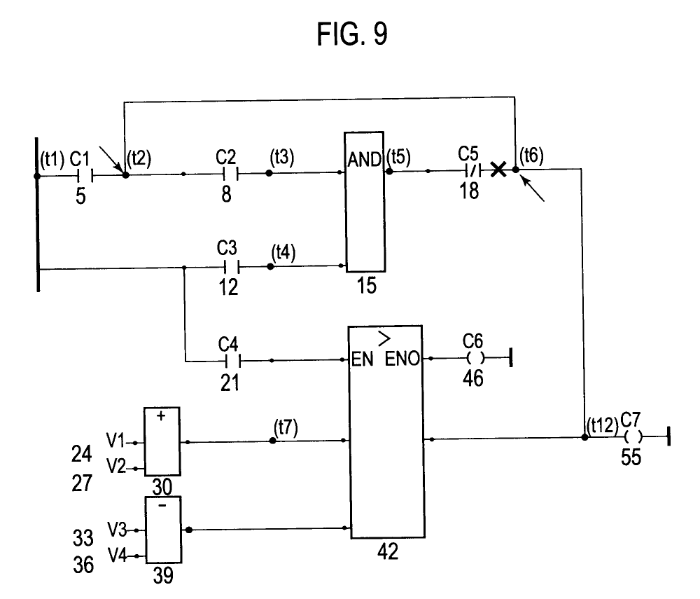

FIG. 9 illustrates this diagram having internal variables (t1)˜(t7) and an internal variable (t12) set therein. In the illustrated diagram, a connecting line between the connecting point of the internal variable (t6) and the connecting point of the contact point C5 is cut off, and the internal variable (t2) as a starting point is connected to the internal variable (t12) as an ending point, so that an input to the internal variable (t6) is cut off to bypass a circuit between the internal variable (t2) and the internal variable (t6).

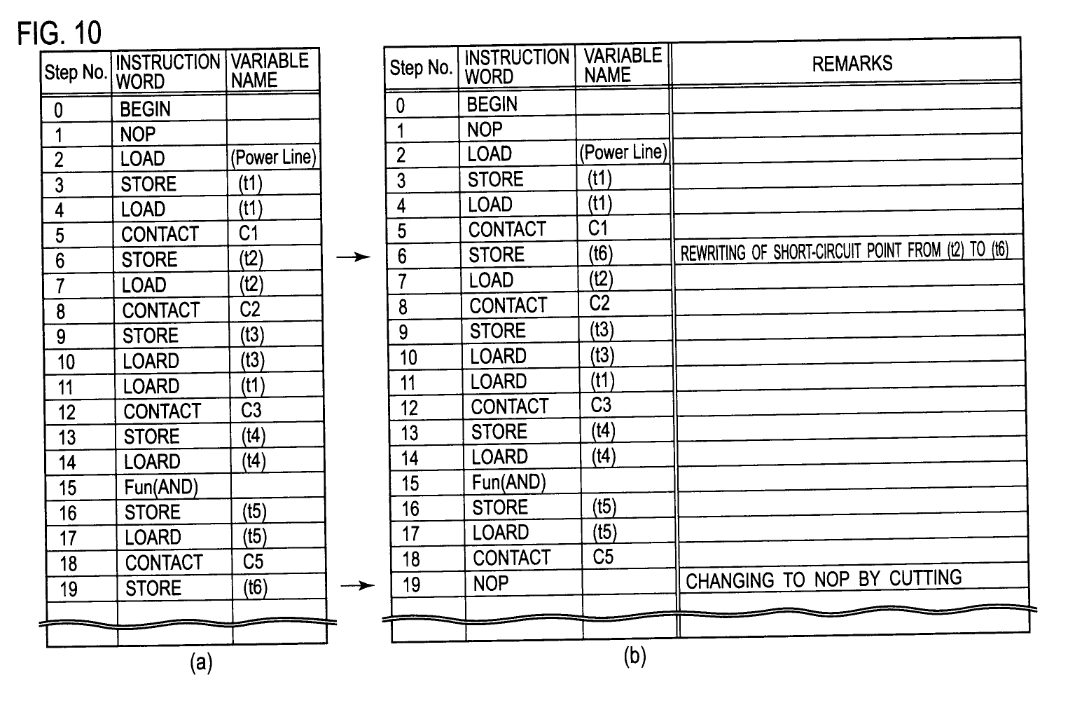

Next, FIG. 10 illustrates an object control program based on this diagram. FIG. 10(a) shows a diagram produced in advance, while FIG. 10(b) shows an example of shorting a circuit with respect to this diagram.

First, an instruction of “STORE” at step 19 is rewritten to an instruction of “NOP” to cut off the input to the internal variable (t6). In addition, the variable of an instruction of “STORE” at step 6 is rewritten from (t2) to the internal variable (t6) to cause short circuit between the internal variable (t2) and the internal variable (t6).

By representing a symbol “X” for a breakpoint of the connecting line and further representing markers, such as arrows, for the starting and ending points of short circuit, it is also possible to make the starting point and the ending point visible on the screen with ease.

Establishing of such a bypass line facilitates the debugging of the diagram.

### 3^{rd}. Embodiment

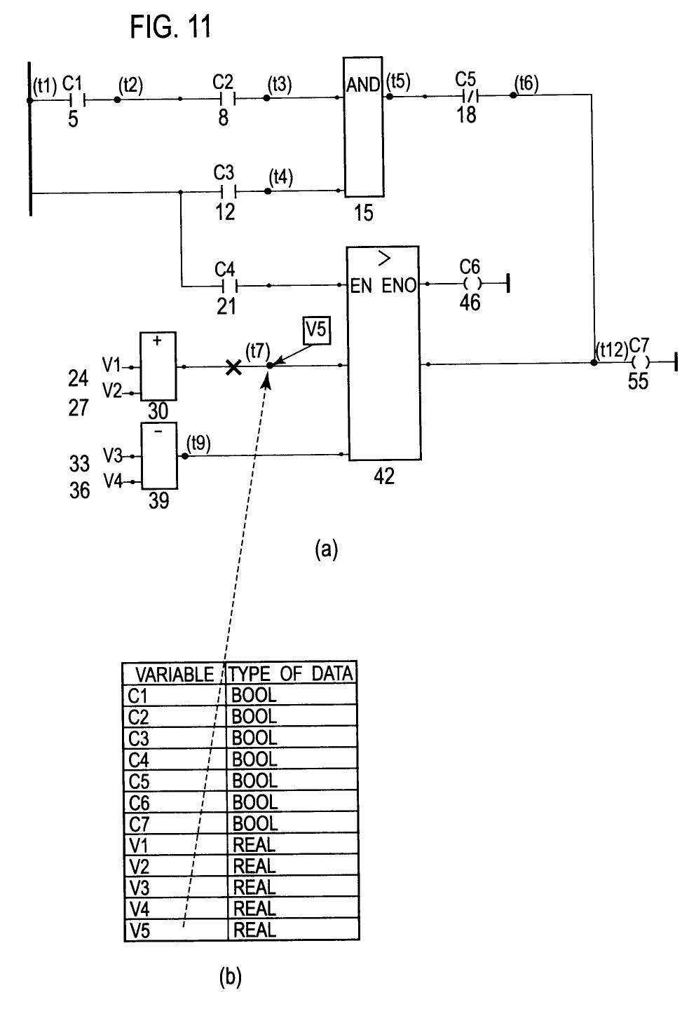

Next, the diagram debug system of the PLC in accordance with the third embodiment of the present invention will be described with reference to FIG. 11. In the third embodiment, respective parts identical to those of the debug system of the PLC of the first embodiment are indicated with the same reference numerals respectively, and their descriptions are eliminated.

The third embodiment differs from the first embodiment in that the wire force setting processing unit 11 of the first embodiment has the function of cutting off a connecting line and also setting an internal variable of the connecting point, while the same unit of the third embodiment further has an additional function of displaying a variable list produced in advance [(FIG. 11(b)] on the screen thereby to speed up the debugging of a circuit.

The operation will be described with reference to a diagram of FIG. 11, below. In the diagram shown in FIG. 11, elements identical to those of the diagram described with FIG. 8 are indicated with the same reference numerals respectively, and their descriptions are eliminated.

The diagram of FIG. 11(a) differs from the diagram of FIG. 8 in that, between an output terminal of the FBD “+ (adder)” and an input terminal of the FBD “> (comparator)”, a connecting line from the output terminal of the FBD “+ (adder)” to a connecting point having the internal variable (t7) is cut off. Further, a variable table is produced from variables shown in FIG. 11(b) in advance. Further, by selecting a variable from the variable table on condition of displaying it on the screen, a variable “V5” is written into the diagram directly and set as the internal variable of the connecting point.

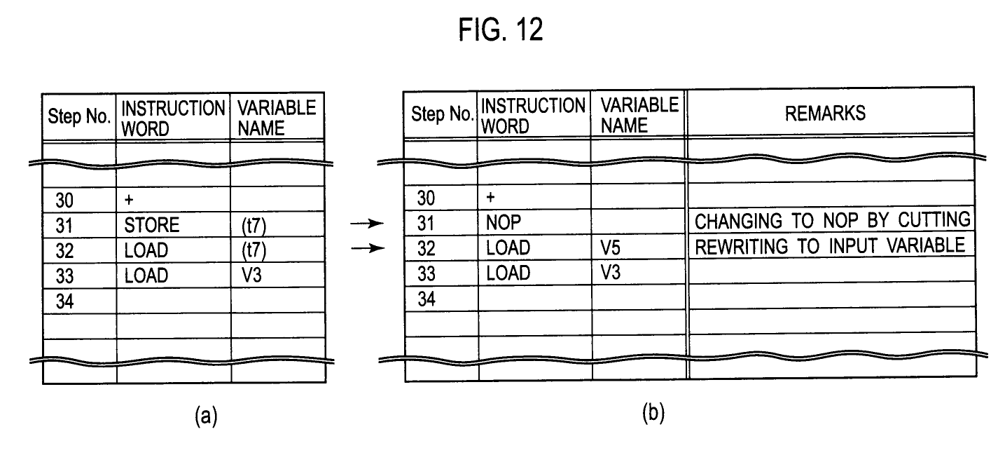

As shown in FIG. 12, this instruction is carried out by changing an instruction of “STORE” at step 31 of FIG. 12(a) to an instruction of “NOP” to cut off the input to the internal variable (t7) and additionally rewriting the internal variable of an instruction of “LOAD” at step 32 from (t7) to “V5”.

In this way, by setting a variable as a result of changing the preset internal variable, it is possible to validate the function of the FBD etc. quickly.

### 4^{th}. Embodiment

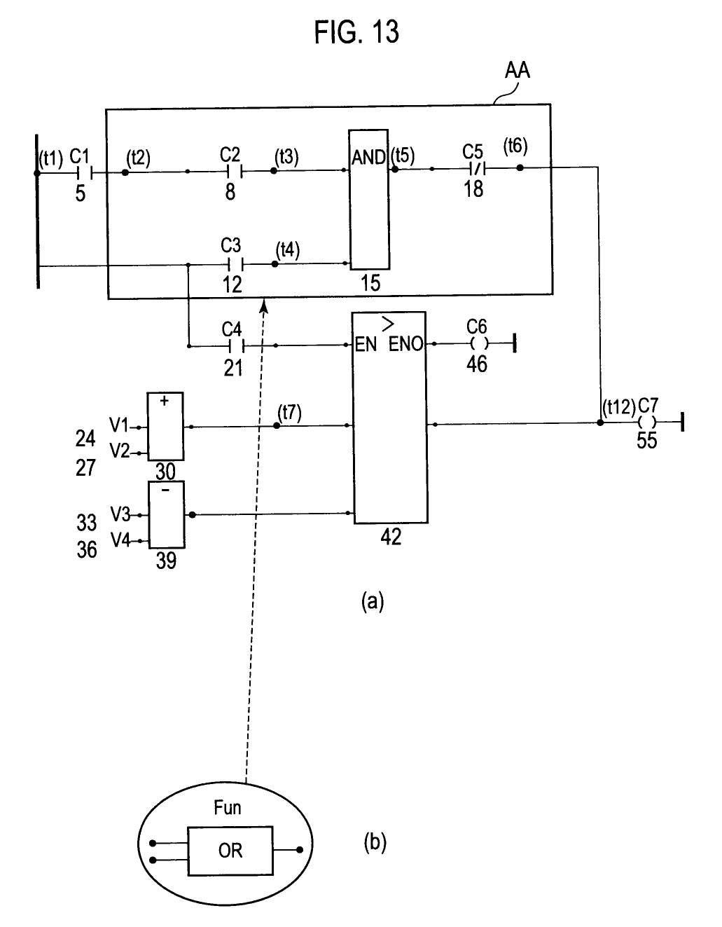

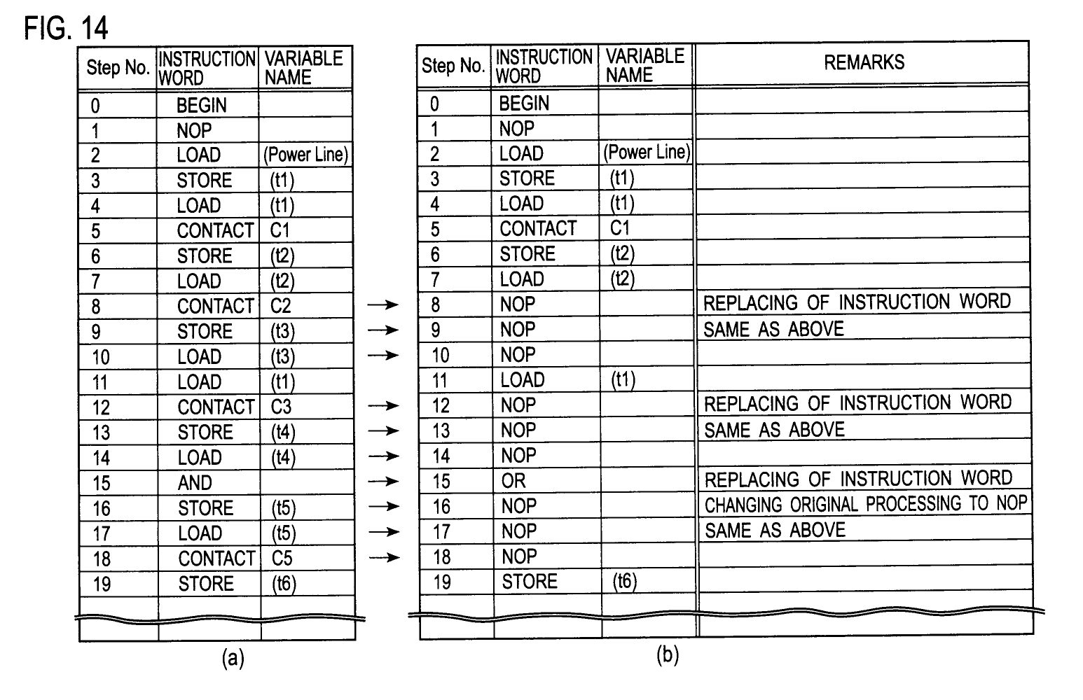

The diagram debug system of the PLC in accordance with the fourth embodiment of the present invention will be described with reference to FIGS. 13 and 14. In the fourth embodiment, respective parts identical to those of the debug system of the PLC of the first embodiment are indicated with the same reference numerals respectively, and their descriptions are eliminated.

The fourth embodiment differs from the first embodiment in that the wire force setting processing unit 11 of the first embodiment has the function of cutting off a connecting line and also setting an internal variable of the connecting point, while the same unit of the fourth embodiment operates to previously set a diagram area having a plurality of connecting points, further cut off a connecting line in the diagram area and replace input/output of this area by preset symbols, allowing debugging of the circuit.

The operation will be described with reference to a diagram of FIG. 13 and an object control program of FIG. 14, below. In the diagram of FIG. 13, elements identical to those of the diagram of FIG. 8 are indicated with the same reference numerals respectively, and their descriptions are eliminated.

The diagram of FIG. 13(a) differs from the diagram of FIG. 8 in that the control program standard processing unit 11a is provided with a not-shown area replacing unit for setting an area AA surrounded by the internal variable (t2) and the internal variable (t6) and that the wire force setting processing unit 11b serves to cut off an input connecting line to the internal variable (t2) and an output connecting line from the internal variable (t6), while the area replacing unit serves to replace this area by a previously-registered symbol shown in FIG. 13(b).

The object control program to be changed at that time is shown in FIG. 14. That is, by rewriting all the instructions at steps 8˜10 of FIG. 14(a), 12˜14 and steps 16˜18 to the instructions of “NOP” and also rewriting the instruction at step 15 to the instruction of “OR”, it is possible to replace the FBD “AND” and a circuit extending from a contact instruction C2 to a contact instruction C5 both connected to the FBD “AND” by a single instruction of FED “OR” shown at step 15.

In this way, by first screen-handling a diagram on the display screen thereby to previously set an optional area in the diagram, secondly cutting off an input to the so-established area from the outside and an output from the same area in the diagram before replacement and successively replacing the area by the instruction of a symbol stored in advance, the function of the same area is simplified to enable debugging outside the area to be performed quickly.

### 5^{th}. Embodiment

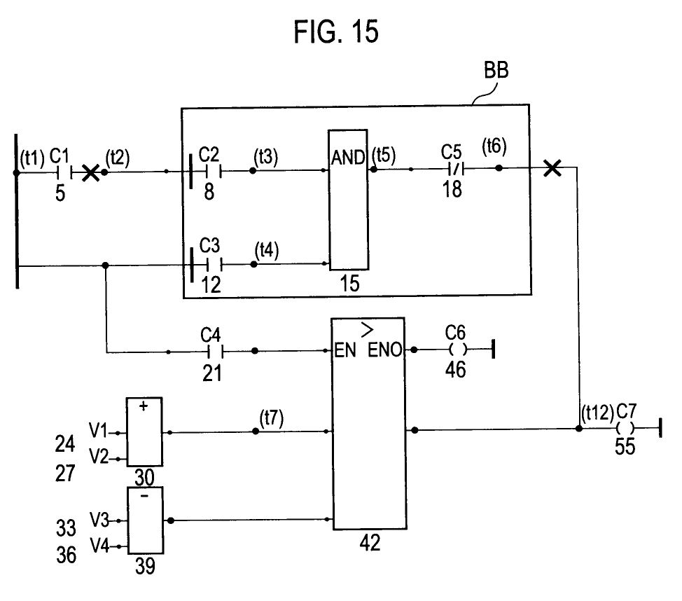

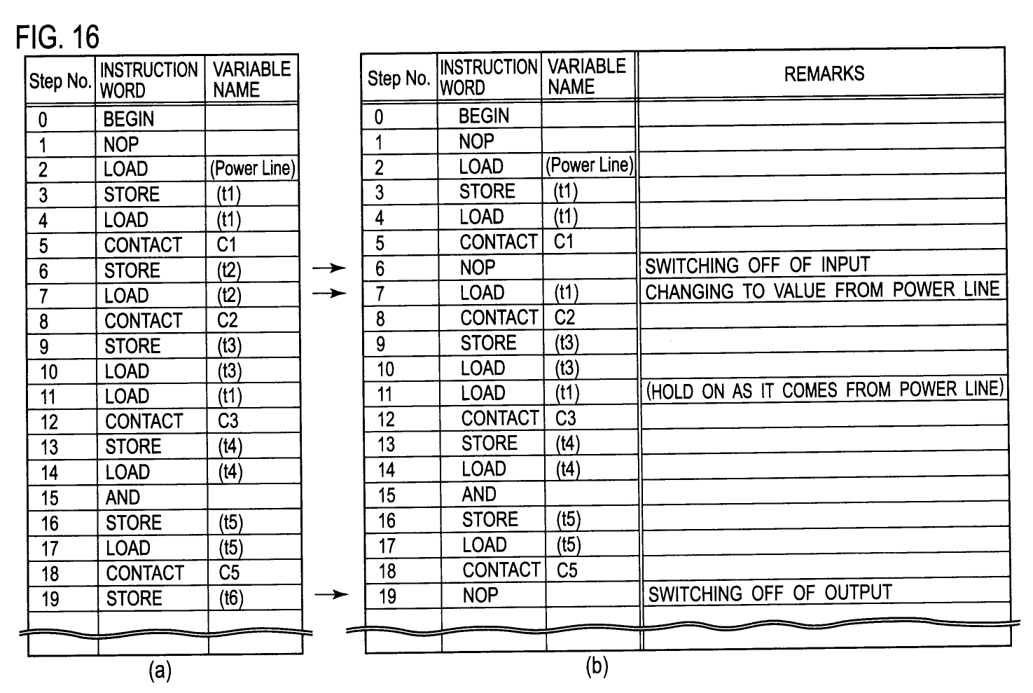

The diagram debug system of the PLC in accordance with the fifth embodiment of the present invention will be described with reference to FIGS. 15 and 16, below. In the fifth embodiment, respective parts identical to those of the debug system of the programmable controller of the first embodiment are indicated with the same reference numerals respectively, and their descriptions are eliminated.

The fifth embodiment differs from the first embodiment in that the wire force setting processing unit 11 of the first embodiment has the function of cutting off a connecting line and also setting an internal variable of the connecting point, while the control program compilation processing unit 11a of the fifth embodiment is provided with a not-shown area setting processing unit for previously setting a diagram area having a plurality of connecting points, and the wire force setting processing unit 11b serves to cut out the diagram area from the diagram thereby enabling debugging of this area only.

The operation will be described with reference to a diagram of FIG. 15 and an object control program of FIG. 16, below. In the diagram of FIG. 15, elements identical to those of the diagram of FIG. 8 are indicated with the same reference numerals respectively, and their descriptions are eliminated.

The diagram of FIG. 15 differs from the diagram of FIG. 8 in that an area BB surrounded by the internal variable (t2) and the internal variable (t6) is set in the diagram and that the connecting lines from the internal variable (t2) and the internal variable (t6) are together cut off to enable debugging to be limited to an inside of the area BB.

The object control program to be changed at that time is shown in FIG. 16. That is, the instructions at steps 6 and 19 of FIG. 16(a) are rewritten to the instructions of “NOP” to cut out the diagram outside the area, and the internal variable at step 7 is set to (t1) to supply the diagram with power.

In this way, by previously setting an area in the diagram, further establishing a power line to an internal variable forming an input to this area and by cutting off an unnecessary connection of the area with the outside, it becomes possible for the programming device 1 to carry out a quick debugging of only a specified area.

The present invention is not limited to the above-mentioned embodiments, and if only the cutoff and short-circuiting of a circuit in the diagram is accomplished by setting an internal variable to an optional connecting point, various modifications could be made without departing from the scope of the invention.

### INDUSTRIAL APPLICABILITY

According to the present invention, in a debug system for diagram of a programmable controller, which produces a diagram made with the use of ladder diagram language and function block diagram language and displays the diagram on a display screen and which produces an object control program based on the diagram, it is possible to carry out an easy debugging of the diagram having connecting points including a branch point of the operating control program.

1. A debug system for diagram, which consists of a programming device for producing a diagram on a display screen by a predetermined diagram language and further producing an object control program based on the diagram and a programmable controller for loading the object control program thereby to execute it, the programming device comprising:
a control program compilation processing unit for producing the object control program that generates, with respect to a connecting point for connecting symbols displayed on the display screen:
a first instruction for designating a connecting state on an input side of the connecting point and a connecting destination thereof;
a first internal variable;
a second instruction for designating a connecting state on an output side of the connecting point and a connecting destination thereof; and
a second internal variable, and
a wire force setting processing unit for commanding that the first instruction and the first variable are rewritten to a third instruction and a third variable or that either one of the first instruction and the first variable is rewritten to the third instruction or the third variable and also commanding that the second instruction and the second variable are rewritten to a fourth instruction and a fourth variable or that either one of the second instruction and the second variable is rewritten to the fourth instruction or the fourth variable, wherein
when a change order for changing the connecting states and the connection destinations on the input side and the output side of the connecting point is transmitted from the programming device to the programmable controller, the programmable controller carries out debugging of the diagram based on the change order during execution of the object control program.

2. The debug system for diagram of claim 1, wherein:
when forming the third instruction by no treatment, cutting off one connecting destination of the diagram and further replacing the fourth internal variable by a preset value, the programmable controller carries out debugging of the diagram on the downstream side of the so-cut connecting point during execution of the object control program.

3. The debug system for diagram of claim 2, wherein:
the first instruction is formed by an instruction of “STORE”;
the second instruction is formed by an instruction of “LOAD”; and
the third instruction is formed by an instruction of “NOP”.

4. The debug system for diagram of claim 1, wherein:
when forming the third internal variable by a preset internal variable of a connecting destination of the diagram and also forming the fourth instruction by no connection, the programmable controller forms a bypass circuit for the diagram and carries out debugging of the diagram during execution of the object control program.

5. The debug system for diagram of claim 4, wherein the fourth instruction is formed by an instruction of “NOP”.

6. The debug system for diagram of claim 4, wherein:
a variable list having variables listed in advance is displayed on the display screen; and
the fourth internal variable is set with use of the variable list on the display screen.

7. The debug system for diagram of claim 1, wherein:
the control program compilation processing unit includes an area replacing unit that sets an optional area of the diagram on the display screen and replaces the area by a preset fifth instruction;
the wire force setting processing unit cuts off an input to the area from an outside thereof and an output from the area in the diagram before replacing the area; and
the programmable controller replaces the area of the diagram by the fifth instruction and carries out debugging of the diagram during execution of the object control program.

8. The debug system for diagram of claim 1, wherein:
the control program compilation processing unit includes an area setting processing unit that sets an optional area of the diagram on the display screen;
the wire force setting processing unit rewrites the third instruction of the connecting point providing an input for the area into non-connection, sets the third instruction to a power line and also rewrites the fourth instruction of the connecting point providing an output from the area into non-connection; and
the programmable controller separates the area from the diagram and carries out debugging of the area independently.

9. A programming device in a debug system for diagram, which consists of the programming device for producing a diagram on a display screen by a predetermined diagram language and further producing an object control program based on the diagram and a programmable controller for loading the object control program thereby to execute it, the programming device comprising:
a control program compilation processing unit for producing the object control program that generates, with respect to a connecting point for connecting symbols displayed on the display screen:
a first instruction for designating a connecting state on an input side of the connecting point and a connecting destination thereof;
a first internal variable;
a second instruction for designating a connecting state on an output side of the connecting point and a connecting destination thereof; and
a second internal variable, and
a wire force setting processing unit for commanding that the first instruction and the first variable are rewritten to a third instruction and a third variable or that either one of the first instruction and the first variable is rewritten to the third instruction or the third variable and also commanding that the second instruction and the second variable are rewritten to a fourth instruction and a fourth variable or that either one of the second instruction and the second variable is rewritten to the fourth instruction or the fourth variable.

10. A program of a debug system for diagram, which consists of a programming device for producing a diagram on a display screen by a predetermined diagram language and further producing an object control program based on the diagram and a programmable controller for loading the object control program thereby to execute it, the program having:
a control program compilation function of producing the object control program that generates, with respect to a connecting point for connecting symbols displayed on the display screen:
a first instruction for designating a connecting state on an input side of the connecting point and a connecting destination thereof;
a first internal variable;
a second instruction for designating a connecting state on an output side of the connecting point and a connecting destination thereof; and
a second internal variable, and
a wire force setting processing function of commanding that the first instruction and the first variable are rewritten to a third instruction and a third variable or that either one of the first instruction and the first variable is rewritten to the third instruction or the third variable and also commanding that the second instruction and the second variable are rewritten to a fourth instruction and a fourth variable or that either one of the second instruction and the second variable is rewritten to the fourth instruction or the fourth variable, wherein
when a change order for changing the connecting states and the connection destinations on the input side and the output side of the connecting point is transmitted from the programming device to the controller, the programmable controller carries out debugging of the diagram based on the change order during execution of the object control program.
